(19) United States
(12) Patent Application Publication
(10) Pub. No.: US 2008/0016189 A1
(43) Pub. Date: Jan. 17, 2008

(54) Host terminal to provide device configuration information, a method thereof, and devices to receive configuration information from the host terminal

(75) Inventor: Hyung-jae Yoo, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/705,438

(22) Filed: Feb. 13, 2007

(30) Foreign Application Priority Data
Jul. 12, 2006 (KR) 2006-65572

(51) Int. Cl. G06F 15/177

(52) U.S. Cl. 709/220

(57) ABSTRACT

A host terminal to provide device configuration information, a method thereof, and devices to receive the configuration information from the host terminal. In a host terminal communicating with at least one device connected thereto via a communication network, a user interface generates configuration information containing set options of functions provided by the at least one device, a description generating unit generates a prescribed description file from the generated configuration information, and a first stack unit transmits the generated description file to the connected devices.

### CROSS-REFERENCE TO RELATED APPLICATIONS

This application claims priority under 35 U.S.C. §119(a) from Korean Patent Application No. 2006-65572 filed Jul. 12, 2006, in the Korean Intellectual Property Office, the entire disclosure of which is hereby incorporated in its entirety by reference.

### BACKGROUND OF THE INVENTION

1. Field of the Invention

The present general inventive concept relates to a host terminal to provide device configuration information, a method thereof, and one or more devices to receive the configuration information from the host terminal. More particularly, the present general inventive concept relates to a host terminal to provide device configuration information in which the host terminal sets the configuration information of one or more devices to register it in the devices according to an UPnP standard, a method thereof, and one of more devices to receive the configuration information from the host terminal.

2. Description of the Related Art

A Universal Plug and Play (UPnP) specification provides a PnP function to a network based on Internet standard technology, such as TCP/IP, HTTP, and XML, and can be applied to a variety of electronic devices, such as home appliances, network printers, etc.

In the UPnP specification, devices in a network are classified into control points (CPs), and controlled devices (CDs) that are controlled by the control device.

When the device is connected to the network, it transmits its configuration information to a host terminal using an UPnP method. When the configuration information is changed, the device sends the changed configuration information to the host terminal.

The configuration information of the device indicates a function that can be provided by the device and a state of the device, and is set by the device itself or through a web service. Each time the device is connected to a network, the configuration information is transmitted to the host terminal. When web service is used, a user accesses a Web-UI (User Interface) of the device through a web browser of the host terminal to set the configuration information of the device.

However, when the configuration information of the device is set through the Web-UI, a plurality of host terminals may have different configuration information to be set in one device. This may cause the device to perform a different operation from that which is requested by a user, who has directly requested the device to perform a particular operation. That is, although the user requests a first function based on first configuration information set by a first host terminal, the requested first function is performed based on second configuration information if the second configuration information has been set by a second host terminal. This leads to an unwanted result.

Furthermore, when a number of devices are connected in a network, a manager or a user must manually reset configuration information, directly on the device or through a host terminal's Web-UI, by the number of the devices connected.

Furthermore, when a first host terminal connected to one device moves from a first network to a second network and is connected to a new device, a manager or a user must manually reset configuration information that is the same as or different from that used in the first network.

### SUMMARY OF THE INVENTION

The present general inventive concept provides a host terminal providing device configuration information, a method thereof, and one or more devices to receive the configuration information from the host terminal which are capable of solving a problem of setting configuration information by a number of devices by the host terminal to set the device configuration information to provide the set device configuration to the devices according to a UPnP standard.

The present general inventive concept also provides a host terminal to provide device configuration information, a method thereof, and one or more devices to receive the configuration information from the host terminal which are capable of displaying configuration information set at a number of host terminals to a user by the device composing the configuration information and arranging and storing them according to a predetermined reference.

The present general inventive concept also provides a host terminal to provide device configuration information, a method thereof, and one or more devices to receive the configuration information from the host terminal which are capable of solving a problem of resetting device configuration information in a host terminal itself, such as an individual computer or a laptop computer, each time the host terminal is connected to a new network.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a host terminal to communicate with at least one device connected thereto via a communication network, the host terminal including a user interface to generate configuration information that contains set options of functions provided by the at least one device, a description generating unit to generate a prescribed description file from the generated configuration information, and a first stack unit to transmit the generated description file to the at least one connected device.

The description generating unit may update the description file to reflect changed options when the set options of the functions are changed through the user interface.

The first stack unit may include a first storage unit to store the generated description file.

When the host terminal is powered on and connected to the network, the first stack unit may multicast the description file stored in the first storage unit to the at least one device.

When the host terminal is disconnected from the communication network, the first stack unit may transmit a termination message to the at least one device.

The foregoing and/or other aspects and utilities of the present general inventive concept may also be achieved by providing a device to receive configuration information from one or more host terminals, the device including a second stack unit to receive a description file from at least one of the host terminals connected to the device via a network and to parse the received description file to extract configuration information that contains options of executable functions, an information managing unit to compose the extracted configuration information to correspond to each of the executable functions, and a control unit to perform the functions based on the composed configuration information in response to a request to perform the functions.

When the description file corresponding to the configuration information is updated, the second stack unit may request to transmit the updated description file.

When the updated description file is received, the second stack unit may parse the updated description file to extract the updated configuration information, and the information managing unit recomposes the updated configuration information.

The device may further include a display unit to display an interface screen to display options of the composed configuration information on the basis of functions, the interface screen being generated by the control unit.

When there is a request to perform a first function of the functions, the control unit may control the display unit to display an option related to the first function among the options of the composed configuration information, and perform a function corresponding to a selected option of the displayed options.

The information managing unit may include a second storage unit to store the composed configuration information for each function.

When the second stack unit receives a termination message from a disconnected host terminal, the control unit may delete configuration information corresponding to the host terminal that transmits the termination message from the second storage unit.

The foregoing and/or other aspects and utilities of the present general inventive concept may also be achieved by providing a method of providing configuration information at a host terminal that communicates with at least one device connected thereto via a communication network, the method including generating the configuration information, the configuration information containing set options of functions provided by the at least one device, generating a prescribed description file from the generated configuration information, and transmitting the generated description file to the at least one connected device.

The method may further include updating the description file to reflect a changed set option when the set option of the functions is changed after transmitting the generated description file.

The method may further include, receiving and parsing, by each device, the description file to extract the configuration information, composing the extracted configuration information for each function, and when there is a request to perform the functions, performing the functions based on the composed configuration information.

The receiving and parsing of the description file may include requesting to transmit an updated description file when the description file is updated.

The method may further include, extracting the updated configuration information and recomposing each option of the updated configuration information for each function when the updated description file is received.

The performing of the functions may include when there is request to perform the functions, creating and displaying an interface screen to display each option of the composed configuration information according to each function, when there is a request to perform a first function of the functions on the displayed interface screen, extracting and displaying options related to the first function from the options of the composed configuration information, and when the first option is selected from the displayed options, performing a function corresponding to the first selected option.

The composing of the extracted configuration information may include storing the composed configuration information.

The method may further include, receiving from the host terminal a termination file indicating a disconnection of the host terminal from the network; and when the termination file is received, deleting the stored configuration information.

The foregoing and/or other aspects and utilities of the present general inventive concept may also be achieved by providing a method of a device receiving configuration information from host terminals, the method including receiving a description file from at least one of the host terminals connected to the device via a network, parsing the received description file to extract configuration information that contains options of executable functions, composing the extracted configuration information corresponding to each of the executable functions, and performing the functions based on the composed configuration information in response to a request to perform the functions.

The foregoing and/or other aspects and utilities of the present general inventive concept may also be achieved by providing a network system, including at least one device to receive configuration information, a host terminal to generate configuration information that contains set options of functions provided by the at least one device, to generate a prescribed description file from the generated configuration information, and to transmit the generated description file, and a device to receive the description file from the host terminal connected to the device via a network and to parse the received description file to extract configuration information that contains options of executable functions, to compose the extracted configuration information corresponding to each of the executable functions, and to perform the functions based on the composed configuration information in response to a request to perform the functions.

The foregoing and/or other aspects and utilities of the present general inventive concept may also be achieved by providing a network system, including a host terminal to generate configuration information, to generate a prescribed description file from the generated configuration information, and to output the generated description file.

The foregoing and/or other aspects and utilities of the present general inventive concept may also be achieved by providing a network system, including a device to receive a description file from at least one host terminal and to parse the received description file to extract configuration information that contains options of executable functions, to compose the extracted configuration information corresponding to each of the executable functions, and to perform the functions based on the composed configuration information in response to a request to perform the functions.

The network may further include a host terminal to set the configuration information of the device according to a universal plug and play (UPnP) standard and to provide the set configuration information to the device.

The configuration information can be applied to the device automatically and in real time by sending the configuration information set by the host terminal without individually setting the configuration information.

The host terminal automatically may send the stored configuration information to the device without resetting the device configuration information.

The host terminal may automatically send the configuration information to the devices when it is activated, and deletes the stored configuration information when the host terminal is disconnected from the communication network.

The foregoing and/or other aspects and utilities of the present general inventive concept may also be achieved by providing a method of communication in a communication network having at least one device and at least one host terminal, the method including generating configuration information that contains set options of functions provided by the at least one device, generating a prescribed description file from the generated configuration information, transmitting the generated description file, receiving the description file from the host terminal connected to the device via a network, parsing the received description file to extract configuration information that contains options of executable functions, composing the extracted configuration information corresponding to each of the executable functions, and performing the functions based on the composed configuration information in response to a request to perform the functions.

The foregoing and/or other aspects and utilities of the present general inventive concept may also be achieved by providing a computer readable recording medium having embodied thereon a computer program to execute a method, wherein the method includes generating configuration information, generating a prescribed description file from the generated configuration information, and outputting the generated description file.

The foregoing and/or other aspects and utilities of the present general inventive concept may also be achieved by providing a computer readable recording medium having embodied thereon a computer program to execute a method, wherein the method includes receiving a description file from at least one host terminal parsing the received description file to extract configuration information that contains options of executable functions, composing the extracted configuration information corresponding to each of the executable functions, and performing the functions based on the composed configuration information in response to a request to perform the functions.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a diagram illustrating a network system including a host terminal and a device according to an embodiment of the present general inventive concept;

FIG. 2 is a block diagram illustrating a host terminal to provide device configuration information, and a device connected to the host terminal according to an embodiment of the present general inventive concept;

FIG. 3 is a diagram illustrating a portion of a description file generated by a description generating unit of the host terminal of FIG. 2;

FIG. 4 is a flowchart illustrating a process of applying to the device configuration information initially set via a UI of the host terminal illustrated in FIG. 2;

FIG. 5 is a flowchart illustrating a process of receiving configuration information applied from the host terminal to the device illustrated in FIG. 2;

FIG. 6 is a flowchart illustrating an operation when the host terminal illustrated in FIG. 2 is connected to a communication network;

FIG. 7 is a flowchart illustrating a process of changing configuration information in the host terminal illustrated in FIG. 2 and transmitting the changed configuration information to the device;

FIG. 8 is a flowchart illustrating an operation of the host terminal when the host terminal illustrated in FIG. 2 is disconnected from a network; and

FIG. 9 is a flowchart illustrating an operation of the device when the host terminal illustrated in FIG. 2 is disconnected from the network.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

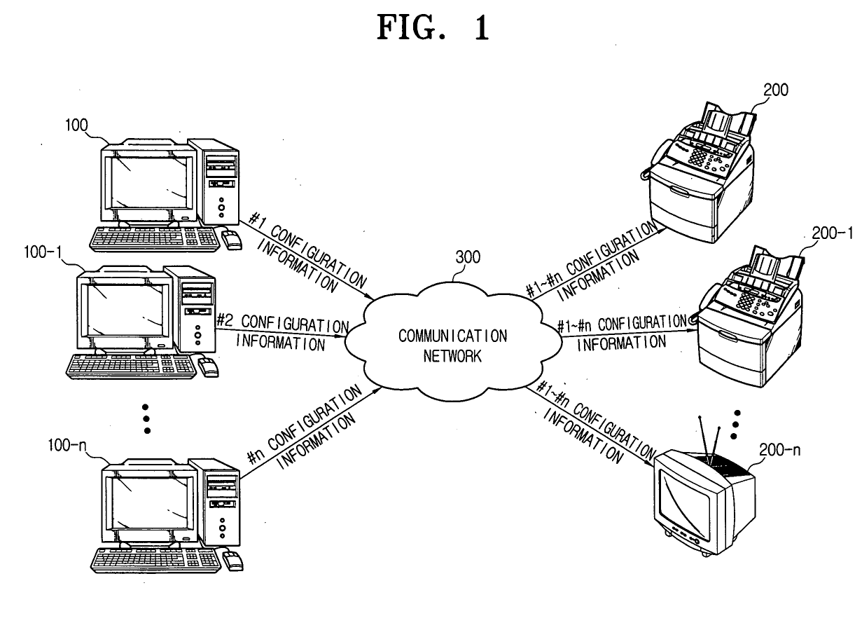

FIG. 1 is a diagram illustrating a network system including a host terminal 100 and a device 200 according to an embodiment of the present general inventive concept.

Referring to FIG. 1, in the network system, a plurality of host terminals 100, 100-1, . . . , and 100-n share a plurality of devices 200, 200-1, . . . , and 200-n (where, n is a positive number) via a network, for example, a communication network 300, in an office or home. The plurality of host terminals 100, 100-1, . . . , and 100-n serve as a control point (CP) or a control point device that issues a command to the plurality of devices 200, 200-1, . . . , and 200-n. The devices 200, 200-1, . . . , and 200-n serve as a controlled device (CD) that receives the command from the host terminals 100, 100-1, . . . , and 100-n.

Particularly, when the plurality of host terminals 100, 100-1, . . . , and 100-n are connected to the communication network 300, they provide previously set configuration information of the devices 200, 200-1, . . . , and 200-n (#1 configuration information, . . . , and #n configuration information, where n is a positive number) to the device 200, 200-1, . . . , and 200-n using a UPnP way (universal plug and play way or specification), respectively. In this case, the plurality of host terminals 100, 100-1, . . . , and 100-n may be CDs and the plurality of devices 200, 200-1, . . . , and 200-n may be CPs.

The configuration information (#1 configuration information, . . . , and #n configuration information) indicates one or more options set for one or more functions of each of the devices 200, 200-1, . . . , and 200-n. For example, for one device function, “Scan to E-mail,” the configuration information may include a number of e-mail addresses.

The configuration information (#1 configuration information, . . . , and #n configuration information) set in the host terminals 100, 100-1, . . . , and 100-n may differ. Accordingly, the respective devices 200, 200-1, . . . , and 200-n arrange and store the configuration information (#1 configuration information, . . . , and #n configuration information) that is received from the plurality of host terminals 100, 100-1, . . . , and 100-n depending on their function or, store the configuration information on the basis of the host terminals 100, 100-1, . . . , and 100-n.

Here, the plurality of host terminals 100, 100-1, . . . , and 100-n set configuration information required to implement the operation of the device 200, 200-1, . . . , and 200-n in consideration of specifications, functions and standards of the plurality of devices 200, 200-1, . . . , and 200-n. The plurality of devices 200, 200-1, . . . , and 200-n have a program installed to allow them to communicate with the host terminals 100, 100-1, . . . , and 100-n using the UPnP way. The plurality of devices 200, 200-1, . . . , and 200-n may be a variety of electronic devices belonging to different categories, such as imaging devices, communication devices, home appliances, and the like. However, the present general inventive concept is not limited thereto.

The imaging devices refer to printers to print data received from a host computer, facsimiles, scanners, copier, or multi-function peripherals having functions of a printer, a facsimile, a scanner, and a copier. The communication devices refer to cellular phones, personal communication service (PCS) telephones, personal digital assistants (PDAs), personal computers (PCs), etc., which can communicate via the communication network 300. The home appliances refer to home products used in home and companies, such as digital TVs, refrigerators, air conditioners, etc. However, the present general inventive concept is not limited thereto.

The communication network 300 can be built by an Internet network based on a hub and a local area network (LAN), as well as a cable connected to a typical parallel port, and a cable connected to a USB port.

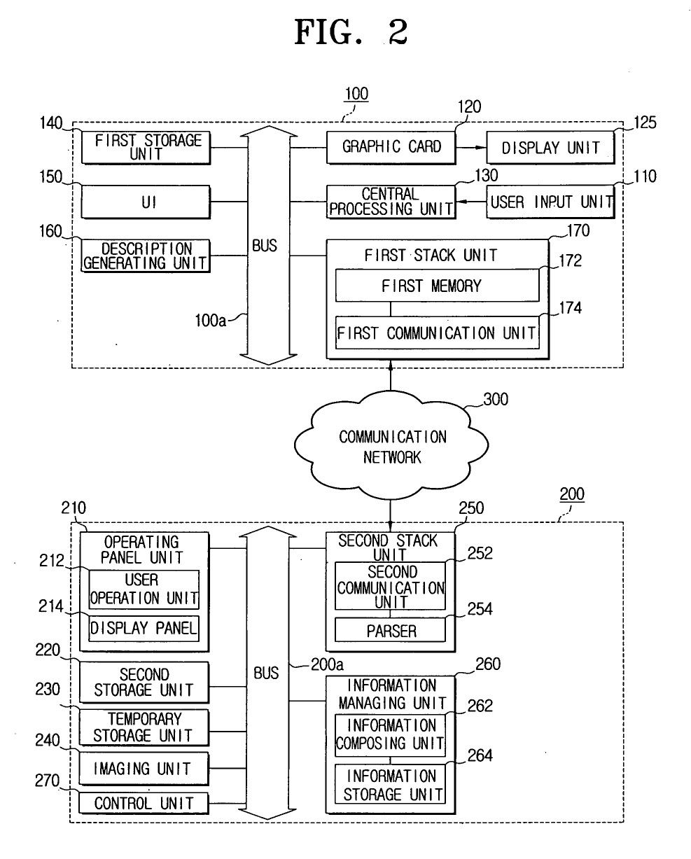

FIG. 2 is a block diagram illustrating a host terminal to provide device configuration information, and a device connected to the host terminal according to an embodiment of the present general inventive concept as illustrated in FIG. 1.

Referring to FIGS. 1 and 2, according to the embodiment of the present general inventive concept, the host terminals 100, 100-1, . . . , and 100-n that provides device configuration information are connected to the number of devices 200, 200-1, . . . , and 200-n via the communication network 300.

As illustrated in FIG. 1, the host terminals 100, 100-1, . . . , and 100-n can be connected to and communicate with the devices 200, 200-1, . . . , and 200-n. Further, the host terminal 100 is described as a personal computer or a lap top computer having a management program required to set the configuration information of the device 200, and the device 200 is described as an imaging device.

The host terminal 100 includes a user input unit 110, a graphic card 120, a display unit 125, a central processing unit 130, a first storage unit 140, a user interface (“UI”) 150, a description generating unit 160, and a first stack unit 170. Blocks or components not related to the present general inventive concept are not illustrated. A bus 100a is a data transmission path among the blocks or components.

The user input unit 110 is a user interface to request functions supported by the host terminal 100 and may include a keyboard, a mouse, a touch panel, and/or the like. The user input unit 110 is used to request a setting of one or more options of the one or more functions provided by the device 200.

The graphic card 120 processes a typical video signal into a displayable signal and outputs the displayable signal to the display unit 125. The graphic card 120 may process a menu screen or a web page generated by the UI 150, which will be described below, and outputs a resulting menu screen or web page to the display unit 125.

The display unit 125 may be a monitor implemented by a cathode ray tube (CRT) or a liquid crystal display (LCD) and may display an operation state, a menu screen, a web page, and the like of the host terminal 100 in response to the signal provided from the graphic card 120.

The central processing unit 130 can control entire operation of the host terminal 100 using various control programs and an operating system (OS) stored in a ROM (not illustrated). In the present general inventive concept, when there is a request from the user input unit 110 to set options of the device 200, the central processing unit 130 executes a management program related to an option setup of the device 200, which is stored in the first storage unit 140.

The first storage unit 140 stores the management program related to the option setup of the device 200, firmware to support a UPnP communication way, and drivers corresponding to the devices 200, 200-1, . . . , and 200-n.

The UI 150 provides a tool to set the options of the functions provided by the device 200. When the options are set on the tool by the operation of the user input unit 110, the UI 150 generates configuration information containing the set option. Here, the tool is in the form of a menu screen to set the options of the functions generated using the installed management program.

For example, when the host terminal 100 operates on the Windows OS supported by Microsoft Corporation and the management program stored in the first storage unit 140 is installed, a shortcut icon corresponding to the management program may be displayed in a tray on an initial screen of the Windows in order to allow the management program to be quickly executed. When the user operates the user input unit 110 to select the icon corresponding to the management program displayed in the Windows tray, the UI 150 executes the management program to create the menu screen under control of the central processing unit 130.

Furthermore, the tool may be a web browser to display a web user interface screen that allows a web user to access a web page through an Internet Protocol (i.e., IP) of the device 200 and set options of the functions.

Meanwhile, when the host terminal 100 is powered off or disconnected from the communication network 300 after the management program is executed, the UI 150 generates a termination message using the management program and provides the termination message to the first stack unit 170.

The description generating unit 160 generates a description file using the configuration information input from the UI 150. The description file has a prescribed format and is generated by, for example, an eXtensible Markup Language (XML).

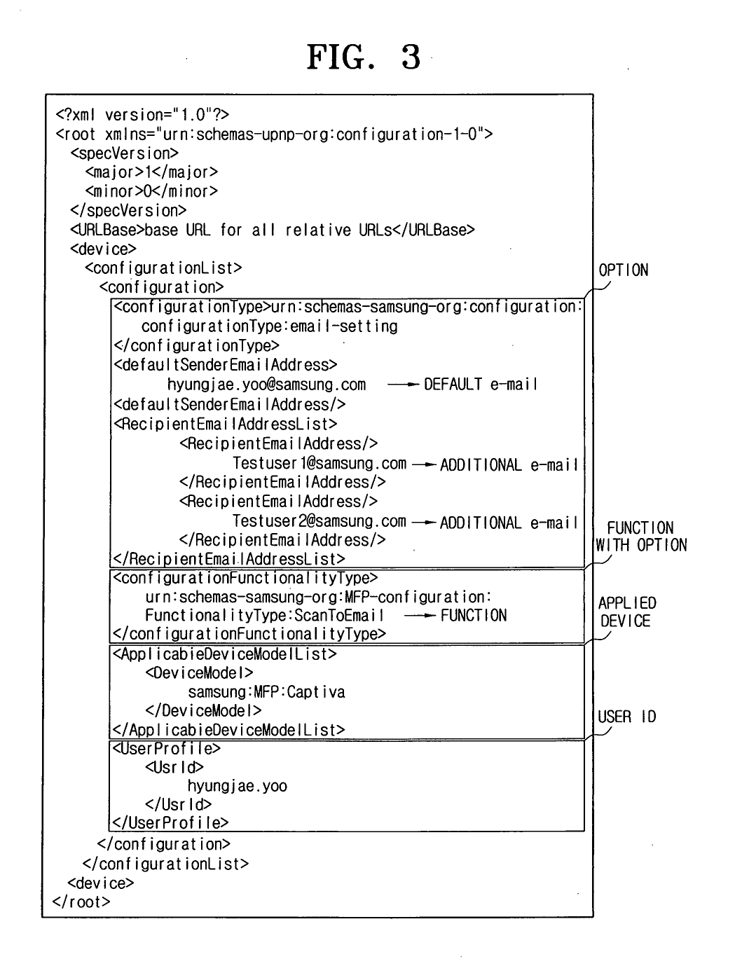

FIG. 3 is a diagram illustrating a portion of the description file generated by the description generating unit of FIG. 2.

Referring to FIG. 3, the description file generated by the description generating unit 160 is divided into areas indicating “option,” “functions to be applied with option,” “devices to be applied with set option,” and “user ID.”

The “option” is information to be actually used by the device 200 and includes, for example, a default e-mail address and additional e-mail addresses to which images generated by the device 200 will be sent. The default e-mail address is an initial value set in the host terminal 100, and the additional e-mail addresses may be e-mail addresses on an address list provided from programs such as the Outlook Express.

The area “Functions to be applied with option” may be functions to be applied with options set in the area “option,” and be “Scan To Email.” The area “Scan To Email” is a function allowing the device 200 to scan a document and then send it to set e-mail addresses.

The area “Device to be applied with set option” is a section to set devices to which the function such as “Scan To Email” is to be applied.

The area “User ID” indicates an ID of a user who sets the options. The User ID may indicate a user logging on the host terminal 100, and the present general inventive concept is not limited thereto.

The description file may therefore include options related to functions such as “Scan to Email” and other functions and is formed by combining the functions into one file.

Referring back to FIG. 2, the first stack unit 170 transmits the generated description file to the device 200 through UPnP multicasting. Further, the first stack unit 170 stores the generated description file in a first memory 172. The description file may be stored before or after transmission to the device 200, which is determined by a manager upon designing the host terminal 100.

The first stack unit 170 includes a first communication unit 174 to store the description file. The first communication unit 174 may be for example a network interface card, which is connected to the communication network 300 and multicasts the stored description file to the device 200. The first communication unit 174 is incorporated into one chip with the first stack unit 170 or disposed as a separate device.

Furthermore, when options of the functions provided by the device 200 are changed by the tool provided by the UI 150, the UI 150 generates an event message indicating the changed option. The description generating unit 160 updates the description file to reflect the changed option, and the first stack unit 170 transmits the updated description file to the device 200. When the host terminal 100 has a number of devices 200, 200-1, . . . , and 200-n connected thereto, the first stack unit 170 transmits the updated description file to all the devices 200, 200-1, . . . , and 200-n.

The first stack unit 170 may transmit the updated description file only to a device that issues a subscribe command among the devices 200, 200-1, . . . , and 200-n. The subscribe command requests to transmit an updated description file when the description file is updated.

Alternatively, when options of the functions provided by the device 200 are changed, the description generating unit 160 generates an XML file that contains the changed options and then provides the XML file to the first stack unit 170. The first stack unit 170 may transmits the XML file including the changed option to the device 200 in response to a request from the description generating unit 160.

Further, the first stack unit 170 stores an XML file corresponding to commands. For example, the first stack unit 170 separately stores an XML termination file to indicate the disconnection from the communication network 300 when the host terminal 100 is disconnected from a network, i.e., the communication network 300. Accordingly, when the host terminal 100 is disconnected from the communication network 300, the description generating unit 160 needs not to generate an XML termination file to indicate the disconnection from the communication network 300.

When the host terminal 100 is powered off or disconnected from the communication network 300 after the management program is executed, the first stack unit 170 receives a termination message generated by the management program. The first stack unit 170 then multicasts an XML termination file corresponding to the stored termination message to the device 200.

According to the embodiment of the present general inventive concept, the device 200 includes an operating panel unit 210, a second storage unit 220, a temporary storage unit 230, an imaging unit 240, a second stack unit 250, an information managing unit 260, and a control unit 270. Blocks or components that have no relation to the present general inventive concept are not illustrated. A bus 200a is a data transmission path among the blocks or components.

The operating panel unit 210 includes a user operation unit 212 and a display panel 214. The user operation unit 212 outputs a signal to operate each function supported by the device 200 to the control unit 270, and includes various function keys and a touch screen.

The display panel 214 displays a task processing state of the device 200 using predetermined characters, symbols, images, etc. under control of the device control unit 270, and is typically implemented by a liquid crystal display (LCD).

The second storage unit 220 stores various control programs required to implement the functions of the device 200, firmware supporting a UPnP communication way, and a program required to parse a description file.

The temporary storage unit 230 stores various data generated by the device 200.

The imaging unit 240 generates image data corresponding to a document and performs a task related to the image data. For example, when the imaging unit 240 includes a scanner, a print engine unit, and a modem (not illustrated), the imaging unit 240 may scan the document, print it on a sheet of paper, copy it, and fax it.

The second stack unit 250 receives the description file, which is transmitted from the first stack unit 170 according to the UPnP standard. The second stack unit 250 includes a second communication unit 252 and a parser 254. The second communication unit 252 receives the description file using a device such as a network interface card, and then outputs the descriptive file to the parser 254. The parser 254 parses the received description file of the XML format and extracts configuration information from the parsing result, i.e., the description file.

After parsing the description file, the second stack unit 250 generates a subscribe command and transmits the subscribe command to the first stack unit 170. The subscribe command requests to transmit an event relating to changed options of the functions to the second stack unit 250 when the host terminal 100 generates the event.

The information managing unit 260 arranges and stores the configuration information extracted by the parser 254 in a predetermined manner. The information managing unit 260 includes an information composing unit 262 and an information storage unit 264 therefore.

The information composing unit 262 is a kind of merger to compose each option of the configuration information according to the functions provided by the device 200. When a plurality of description files are received from the plurality of host terminals 100, 100-1, . . . , and 100-n, each description file includes a different option with respect to the same function. In this case, the information composing unit 262 composes a set option of each function according to each function and each of the host terminals 100, 100-1, . . . , and 100-n or according to each of the host terminals 100, 100-1, . . . , and 100-n.

The information storage unit 264 stores each option composed by the information composing unit 262 according to each function and each of the host terminals 100, 100-1, . . . , and 100-n.

The control unit 270 controls the device 200 using a stored control program. Accordingly, the control unit 270 controls the device 200 based on a result of parsing the description file. The control unit 270 controls the information managing unit 260 to compose and store the configuration information extracted by parsing the description file.

When there is a request from the host terminal 100 or the user operation unit 212 to perform a first function that can be provided by the device 200, the control unit 270 performs the requested function based on the option stored in the information storage unit 264.

More specifically, when there is a request to perform the first function from the host terminal 100 or the user operation unit 212, the control unit 270 reads options related to the first function from the information storage unit 264. That is, the control unit 270 reads the options related to the first function, which are set by and transmitted from the host terminals 100, 100-1, . . . , and 100-n, and then generates an option selection screen that is displayable on the display panel 214. The control unit 270 may read options corresponding to configuration information set by the host terminals 100 and 100-1 that are currently connected to the communication network 300, among the options related to the first function, and generates an option selection screen.

When one option is selected on the option selection screen displayed on the display panel 214 and the user operation unit 212 operates, the control unit 270 processes to perform the first function based on the selected option.

When there is a request to perform the first function from the host terminal 100, the control unit 270 reads only the option set by the host terminal 100, among the options related to the first function stored in the information storage unit 264. The control unit 270 generates an option selection screen which displays only the read option and then displays it on the display panel 214.

For example, when the first function is “Scan To Email”, a number of e-mail addresses set by the plurality of host terminals 100, 100-1, . . . , and 100-n are stored in the information storage unit 264. Accordingly, the control unit 270 reads and displays the stored e-mail addresses. The control unit 270 may read only e-mail addresses set at the host terminal 100 that request the first function, among the stored e-mail addresses.

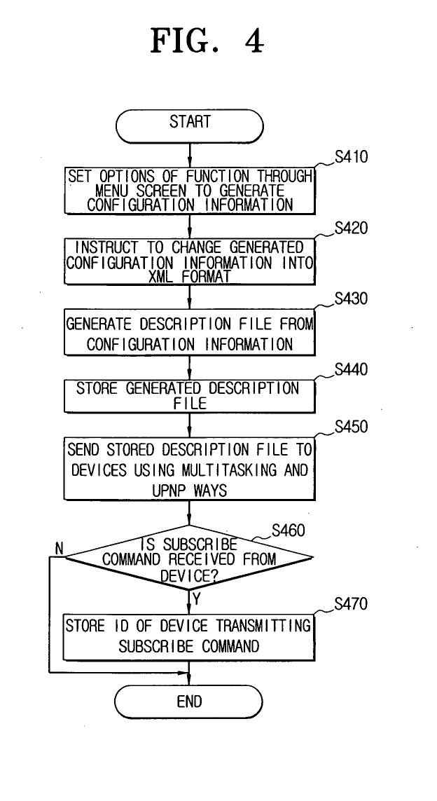

FIG. 4 is a flowchart illustrating a process of applying configuration information initially set via a UI of the host terminal 100 illustrated in FIG. 2 to the device 200.

Referring to FIGS. 1 to 4, when a user operates the user input unit 110 to request to display a menu screen that allows the user to set-configuration information of the device 200, the UI 150 creates the menu screen using a management program stored in the first storage unit 140. Accordingly, the request to display the menu screen is made by the user that selects the icon for the management program, which is displayed on a background screen of Windows or the Windows tray. The generated menu screen is processed to be displayed on the display unit 125.

Options that relate to the function of the device 200 are set through the displayed menu screen and the UI 150 generates configuration information containing the set options in operation S410. In operation S420, the UI 150 instructs the description generating unit 160 to change the configuration information into an XML format.

In response to the instruction from the UI 150, the description generating unit 160 changes the configuration information into the description file of an XML format in operation S430, and the first stack unit 170 stores the generated description file in the first memory 172 in operation S440.

In operation S450, the first communication unit 174 then sends the stored description file to the devices 200, 200-1, . . . , and 200-n connected to the communication network 300 using multitasking and UPnP ways.

When a subscribe command is received from at least one device 200 of the devices 200, 200-1, . . . , and 200-n in operation S460, the first stack unit 170 stores identification information (e.g., ID) of the at least one device 200 transmitting the subscribe command in the first memory 172 in operation S470. Accordingly, a device may send the configuration information containing changed options to be identified when the options of the device 200 are changed through the UI 150.

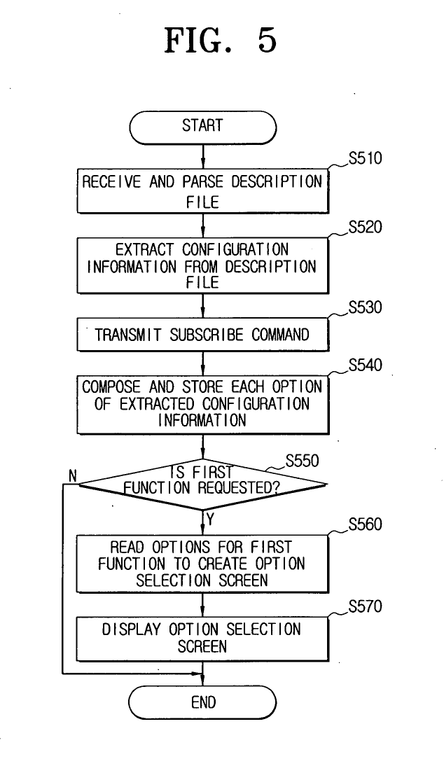

FIG. 5 is a flowchart illustrating a process of applying configuration information that the device 200 illustrated in FIG. 2 initially receives from the host terminal 100.

Referring to FIGS. 1 to 5, when the second communication unit 252 of the second stack unit 250 receives the description file, which is transmitted in operation S450 of FIG. 4, the parser 254 parses the received description file in operation S510 and extracts configuration information from the description file in operation S520.

In operation S530, the second stack unit 250 then transmits the subscribe command to the host terminal 100. The subscribe command requests the host terminal 100 to transmit changed options when the content of the configuration information, i.e., options of each function is changed.

In operation S540, the information managing unit 260 composes and stores each option of the configuration information, extracted in operation S520, for each host terminal 100.

When the device 200 requests a first function among a number of functions in operation S550, the control unit 270 reads options for the first function in the stored configuration information to create an option selection screen in operation S560. The control unit 270 processes the generated option selection screen to be displayed on the display panel 214 in operation S570. When the user operates the user operation unit 212 to select one option on the option selection screen, the control unit 270 performs the first function based on the selected option.

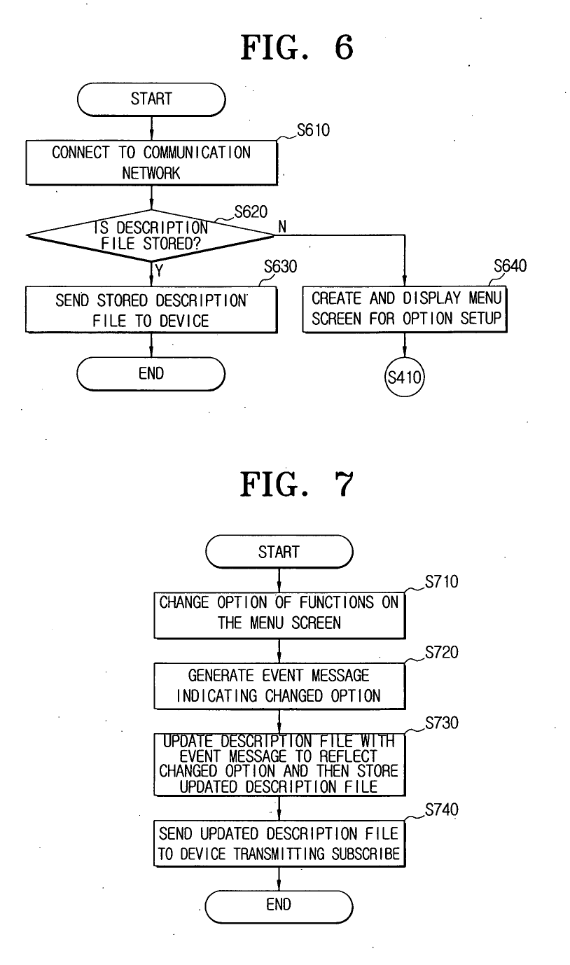

FIG. 6 is a flowchart illustrating an operation when the host terminal 100 illustrated in FIG. 2 is connected to the communication network 300.

Referring to FIGS. 1 to 6, when the host terminal 100 is connected to the communication network 300 in operation S610, the first stack unit 170 checks whether a description file is stored in the first memory 172 in operation S620. Accordingly, the connection in operation S610 is automatically established when the host terminal 100 is powered on, when a user operates the user input unit 110, or when the host terminal 100 is connected to a new network.

In operation S630, if the description file is stored, the first stack unit 170 sends the stored description file to the device 200 using multitasking and UPnP ways.

In operation S640, if the description file is not stored, the first stack unit 170 requests the UI 150 to display a menu screen for option setup. In response to the request, the UI 150 creates the menu screen and processes it to be displayed on the display unit 125.

The host terminal 100 subsequently enters operation S410 of FIG. 11 as desired by the user.

FIG. 7 is a flowchart illustrating a process including transmitting configuration information to the device 200 after the configuration information is changed by the host terminal 100 illustrated in FIG. 2.

Referring to FIGS. 1 to 7, when a previously set option of the functions of the device 200 is changed on the menu screen provided by the UI 150 in operation S710, the UI 150 generates an event message that indicates the changed option and outputs the event message to the description generating unit 160 in operation S720. The event message requests to update the description file so that the changed option is reflected thereto.

The description generating unit 160 updates the description file with the event message to reflect the changed option in operation S720, and the first memory 172 stores the updated description file in operation S730.

The first stack unit 170 then confirms the device 200 transmitting the subscribe command stored in the first memory 172 and controls the first communication unit 174 to send the updated description file only to the confirmed device 200 in operation S740. In this manner, the description file that reflects the changed option is provided only to the device 200 that transmits the subscribe command.

The device 200 that receives the updated description file performs the operation as described in FIG. 5, and accordingly a description of the operation of the device 200 in FIG. 7 will be omitted.

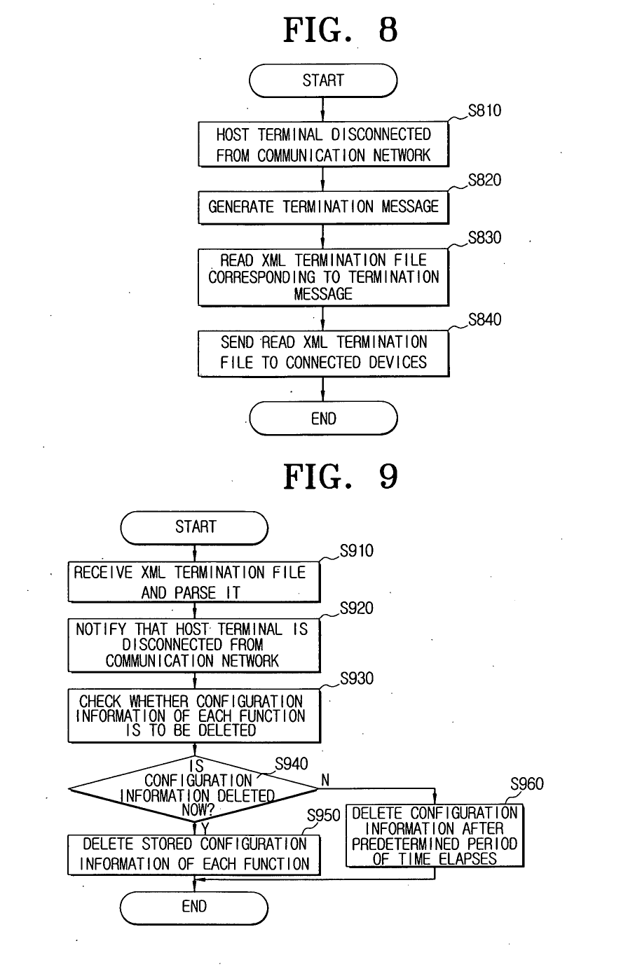

FIG. 8 is a flowchart illustrating an operation of the host terminal 100 when the host terminal 100 illustrated in FIG. 2 is disconnected from the network 300.

Referring to FIGS. 1 to 8, when the host terminal 100 is disconnected from the communication network 300 in operation S810, the UI 150 generates a termination message and outputs the termination message to the first stack unit 170 in operation S820. Accordingly, the disconnection from the communication network 300 occurs when the host terminal 100 is powered off or when the user operates the user input unit 110 to disconnect the host terminal 100 from the communication network 300.

The first stack unit 170 reads a termination file of an XML format corresponding to the input termination message from the first memory 172 in operation S830, and controls the first communication unit 174 to send the termination file to all the connected devices 200, 200-1, . . . , and 200-n in operation S840.

FIG. 9 is a flowchart illustrating an operation of the device 200 when the host terminal 100 illustrated in FIG. 2 is disconnected from the network 300.

Referring to FIGS. 1 to 9, when the second communication unit 252 receives the termination file of the XML format, the parser 254 parses the received termination file in operation S910. In operation S920, the parser 254 then notifies the control unit 270 that the host terminal 100 is disconnected from the communication network 300.

In response to the notification, the control unit 270 checks whether configuration information of each function is to be deleted from the information storage unit 264 in operation S930. Accordingly, the control unit 270 generates a message to check whether the stored configuration information for each function is to be now deleted and displays the message on the display panel 214.

When “Delete Now” is selected by the user operating the operation unit 212 in operation S940, the control unit 270 deletes configuration information, which is transmitted by the host terminal 100 that transmits the termination XML file, among the stored configuration information of each function in operation S950. In contrast, if “Delete Later” is selected by the user operation unit 212, the control unit 270 deletes the stored configuration information of each function after a predetermined period of time elapses in operation S960.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As described above, with the host terminal to provide device configuration information, the method thereof, and the devices to receive the configuration information from the host terminal according to the present general inventive concept, a problem of setting configuration information by the number of the devices can be solved by the host terminal setting the configuration information of the devices according to a UPnP standard and then providing the set configuration information to the devices.

Furthermore, according to the present general inventive concept, a problem of resetting configuration information each time the device is to be used can be solved by storing configuration information, set by a number of host terminals, in a number of devices on the basis of device functions or host terminals. That is, when a number of devices are disposed in a communication network, configuration information can be applied to the devices automatically and in real time by sending configuration information of an XML format set by the host terminal without individually setting configuration information.

Particularly, when moving into a new communication network, the host terminal automatically sends the stored configuration information to the devices without resetting the device configuration information, thereby improving convenience of use.

In addition, configuration information specific to each user is stored in the host terminal, the host terminal automatically sends the configuration information to the devices when it is activated, and deletes the stored configuration information when the host terminal is disconnected from the communication network, thereby increasing utilization of a storage space of the devices.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A host terminal to communicate with at least one device connected thereto via a communication network in a network system, the host terminal comprising:
a user interface to generate configuration information that contains set options of functions provided by the at least one device;
a description generating unit to generate a prescribed description file from the generated configuration information; and
a stack unit to transmit the generated description file to the at least one connected device.

2. The host terminal of claim 1, wherein the description generating unit updates the description file to reflect changed options when the set options of the functions are changed through the user interface.

3. The host terminal of claim 1, wherein the stack unit comprises:
a first storage unit to store the generated description file.

4. The host terminal of claim 3, wherein when the host terminal is powered on and connected to the network, the stack unit multicasts the description file stored in the first storage unit to the at least one device.

5. The host terminal of claim 4, wherein when the host terminal is disconnected from the communication network, the stack unit transmits a termination message to the at least one device.

6. A device to receive configuration information from one or more host terminals in a network system, the device comprising:
a stack unit to receive a description file from at least one of the host terminals connected to the device via a network and to parse the received description file to extract configuration information that contains options of executable functions;
an information managing unit to compose the extracted configuration information corresponding to each of the executable functions; and
a control unit to perform the functions based on the composed configuration information in response to a request to perform the functions.

7. The device of claim 6, wherein when the description file corresponding to the configuration information is updated, the stack unit requests to transmit the updated description file.

8. The device of claim 7, wherein when the updated description file is received, the stack unit parses the updated description file to extract the updated configuration information, and the information managing unit recomposes the updated configuration information.

9. The device of claim 6, further comprising:
a display unit to display an interface screen to display options of the composed configuration information on the basis of functions, the interface screen being generated by the control unit.

10. The device of claim 9, wherein when there is a request to perform a first function of the functions, the control unit controls the display unit to display an option related to the first function among the options of the composed configuration information, and performs the first function corresponding to a selected option of the displayed options.

11. The device of claim 6, wherein the information managing unit comprises:
a storage unit to store the composed configuration information for each function.

12. The device of claim 11, wherein when the stack unit receives a termination message from a disconnected host terminal, the control unit deletes the configuration information corresponding to the host terminal that transmits the termination message, from the storage unit.

13. A method of providing configuration information at a host terminal that communicates with at least one device connected thereto via a communication network in a network system, the method comprising:
generating the configuration information, which contains set options of functions provided by the at least one device;
generating a prescribed description file from the generated configuration information; and
transmitting the generated description file to the at least one connected device.

14. The method of claim 13, further comprising:
updating the description file to reflect a changed set option when the set option of the functions is changed after transmitting the generated description file.

15. The method of claim 13, further comprising:
receiving and parsing, by each device, the description file to extract the configuration information;
composing the extracted configuration information for each function; and
when there is a request to perform the functions, performing the functions based on the composed configuration information.

16. The method of claim 15, wherein the receiving and parsing of the description file comprises:
requesting to transmit an updated description file when the description file is updated.

17. The method of claim 15, further comprising:
extracting the updated configuration information and recomposing each option of the updated configuration information for each function when the updated description file is received.

18. The method of claim 15, wherein the performing of the functions comprises:
when there is request to perform the functions, creating and displaying an interface screen to display each option of the composed configuration information according to each function;
when there is a request to perform a first function of the functions on the displayed interface screen, extracting and displaying options related to the first function from the options of the composed configuration information; and
when the first option is selected from the displayed options, performing a function corresponding to the first selected option.

19. The method of claim 15, wherein the composing of the extracted configuration information comprises:
storing the composed configuration information.

20. The method of claim 19, further comprising:
receiving from the host terminal a termination file indicating a disconnection of the host terminal from the network; and
when the termination file is received, deleting the stored configuration information.

21. A method of a device receiving configuration information from host terminals, the method comprising:
receiving a description file from at least one of the host terminals connected to the device via a network;
parsing the received description file to extract configuration information that contains options of executable functions;
composing the extracted configuration information corresponding to each of the executable functions; and
performing the functions based on the composed configuration information in response to a request to perform the functions.

22. A network system, comprising:
at least one device to receive configuration information;
a host terminal to generate configuration information that contains set options of functions provided by the at least one device, to generate a prescribed description file from the generated configuration information, and to transmit the generated description file; and
a device to receive the description file from the host terminal connected to the device via a network and to parse the received description file to extract configuration information that contains options of executable functions, to compose the extracted configuration information corresponding to each of the executable functions, and to perform the functions based on the composed configuration information in response to a request to perform the functions.

23. A network system, comprising:
a host terminal to generate configuration information, to generate a prescribed description file from the generated configuration information, and to output the generated description file.

24. A network system, comprising:
a device to receive a description file from at least one host terminal and to parse the received description file to extract configuration information that contains options of executable functions, to compose the extracted configuration information corresponding to each of the executable functions, and to perform the functions based on the composed configuration information in response to a request to perform the functions.

25. The network of claim 24, further comprising:
a host terminal to set the configuration information of the device according to a universal plug and play (UPnP) standard and to provide the set configuration information to the device.

26. The network of claim 25, wherein the configuration information can be applied to the device automatically and in real time by sending the configuration information set by the host terminal without individually setting the configuration information.

27. The network of claim 25, wherein the host terminal automatically sends the stored configuration information to the device without resetting the device configuration information.

28. The network of claim 25, wherein the host terminal automatically sends the configuration information to the devices when it is activated, and deletes the stored configuration information when the host terminal is disconnected from the communication network.

29. A method of communication in a communication network having at least one device and at least one host terminal, the method comprising:
generating configuration information that contains set options of functions provided by the at least one device;
generating a prescribed description file from the generated configuration information;
transmitting the generated description file;
receiving the description file from the host terminal connected to the device via a network;
parsing the received description file to extract configuration information that contains options of executable functions;
composing the extracted configuration information corresponding to each of the executable functions; and
performing the functions based on the composed configuration information in response to a request to perform the functions.

30. A computer readable recording medium having embodied thereon a computer program to execute a method, wherein the method comprises:
generating configuration information;
generating a prescribed description file from the generated configuration information; and
outputting the generated description file.

31. A computer readable recording medium having embodied thereon a computer program to execute a method, wherein the method comprises:
receiving a description file from at least one host terminal
parsing the received description file to extract configuration information that contains options of executable functions;
composing the extracted configuration information corresponding to each of the executable functions; and
performing the functions based on the composed configuration information in response to a request to perform the functions.
